(19) United States
(12) Patent Application Publication
(10) Pub. No.: US 2007/0242239 A1
(43) Pub. Date: Oct. 18, 2007

(54) Method and Apparatus for Placing Light Modifying Elements in a Projection Lens

(76) Inventor: Arthur Berman, San Jose, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/279,451

(22) Filed: Apr. 12, 2006

(51) Int. Cl. G03B 21/20

(52) U.S. Cl. 353/102

(57) ABSTRACT

An optical element (e.g., wavelength dependent retarder (ColorSelect), dichroic, and/or optical shutter) is disposed in a projection lens at a point in the projection lens where the area of the light beam being projected is minimized. The optical element(s) is utilized for polarization control and/or brightness leveling or other optical effects. The optical element(s) matches the size and shape of a light ray bundle passing through the minimized point in the projection lens. The minimized size and shape of the optical element(s) reduces the cost of the element(s). The minimized location is for example, between a first and second set of lens in the projection lens. The location also reduces variations in the post optical element light train caused by impacting lens element surfaces. The projection lens is utilized, for example, in a Liquid Crystal on Silicon (LCoS) based High Definition (HD) Rear Projection Television (RPTV).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to projection lenses and more particularly to projection lenses in video projectors.

1. Discussion of Background

The components of a video projector (a projection display) are explained by example of a light engine with reference to FIG. 1. As shown, white light 110 is generated by a light source 105. The light is collected, homogenized, polarized, and formed into the proper shape and otherwise processed by optics (not all shown for clarity). The light then enters a prism assembly 150 where it is broken into red, green and blue polarized light beams. A set of microdisplays 152A, 152B, and 152C are provided and positioned to correspond to each of the polarized light beams (the prism assembly 150 with the attached microdisplays is called a kernel). The beams then follow different paths within the prism assembly 150 such that each beam is directed to a specific reflective microdisplay. The microdisplay that interacts with (reflects) the green beam modulates the green content of a full color video image. Similarly, the red and blue contents of the full color image are modulated by corresponding “red” and “blue” microdisplays. The prism assembly 150 then recombines the modulated beams into a modulated white light beam 160 that contains the full color video image.

The kernel is constructed, for example, from a set of beam splitters. The example kernel in FIG. 1 uses a set of 4 polarizing beam splitters. Depending on the design of the kernel, other optical components (e.g., mainly optical elements such as polarizers, waveplates, ColorSelects, filters, dichroics, optical blanks, etc.) may be disposed at various locations within the kernel. In the example kernel of FIG. 1, certain optical elements are disposed, for example, between adjacent faces of the beam splitters. Typically, as a result of the various optics and design of the kernel, modulated light exiting the kernel is polarized.

The resultant modulated and polarized white light beam 160 then exits the prism assembly 150 and enters a projection lens 165. Finally, the image-containing beam (white light beam 160 has been modulated and now contains the full color image) is projected onto a screen 170.

### SUMMARY OF THE INVENTION

The present inventor has realized the needs to reduce the size of polarization altering components (thus reducing cost) and to minimize the extent to which polarization is undesirably altered by transmission through a projection lens (thus improving image quality). Roughly described, the present invention is the inclusion of an optical element (e.g., wavelength dependent retarder (ColorSelect), dichroic, and/or optical shutter) in a projection lens. The included optical component is disposed, for example, at a point in the projection lens where the area of the light beam to be projected is minimized.

In one embodiment, the present invention provides a projection lens, comprising a first lens group, a second lens group, and a wavelength specific retarder disposed between the first lens group and the second lens group.

In another embodiment, the present invention comprises a video projector, comprising, a modulating kernel configured to modulate an input light with image data, and an output lens configured to project the modulated light, wherein the output lens comprises an output objective lens group and a light modifying element disposed at a minimum modulated light area within the output lens.

In yet another embodiment, the present invention comprises a wavelength specific retarder disposed in a projection lens. The wavelength specific retarder is, for example, a ColorSelect material disposed at a minimum light area within the projection lens. The wavelength specific retarder is, for example, sized and shaped to matched to an area of a light ray bundle passing through the projection lens. The projection lens is, for example, installed in a light path of a High Definition (HD) projection television. The projection television is, for example, a Liquid Crystal Silicon (LCoS) based Rear Projection Television (RPTV).

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a drawing of the components of a video projector;

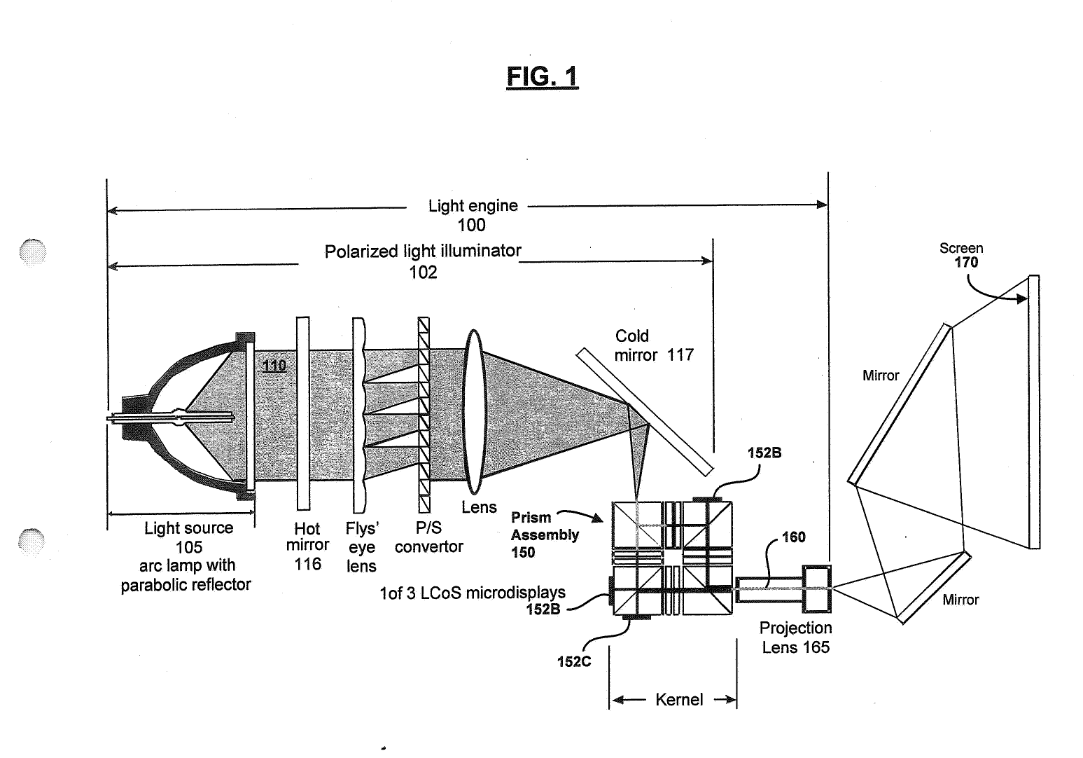

FIG. 2 is a drawing illustrating an example set of lens elements within a generic projection lens;

FIG. 3 is a drawing of a projection lens according to an embodiment of the present invention;

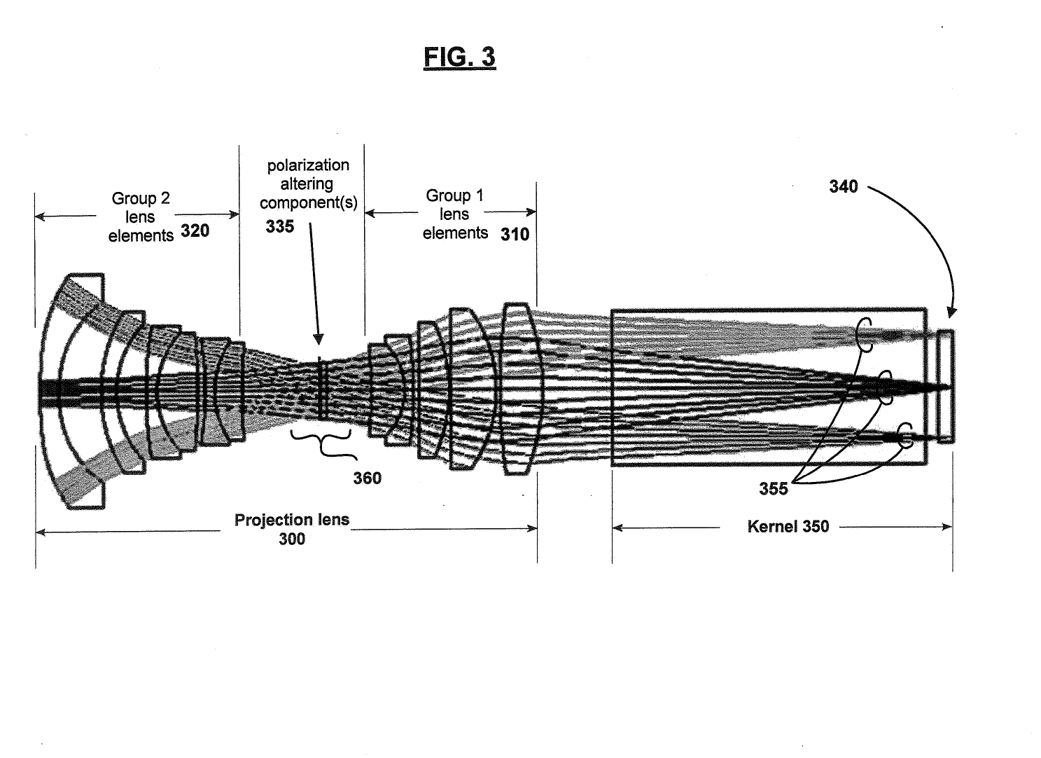

FIG. 4 is a drawing of a projection lens incorporating polarization altering components and a light shutter according to an embodiment of the present invention; and

FIG. 5 is a drawing of a video projector having a projection lens according to an embodiment of the present invention.

### DESCRIPTION OF THE PREFERRED EMBODIMENTS

Some notes and observations on projection lens and projection systems relevant to the present invention are now described. For example, the structure of a video projector requires that the designer match the parameters and requirements of a kernel with that of a projection lens. Together, these components can logically be thought of as one distributed optical system. As a consequence, a change in either section is likely to affect the performance and/or design of the other.

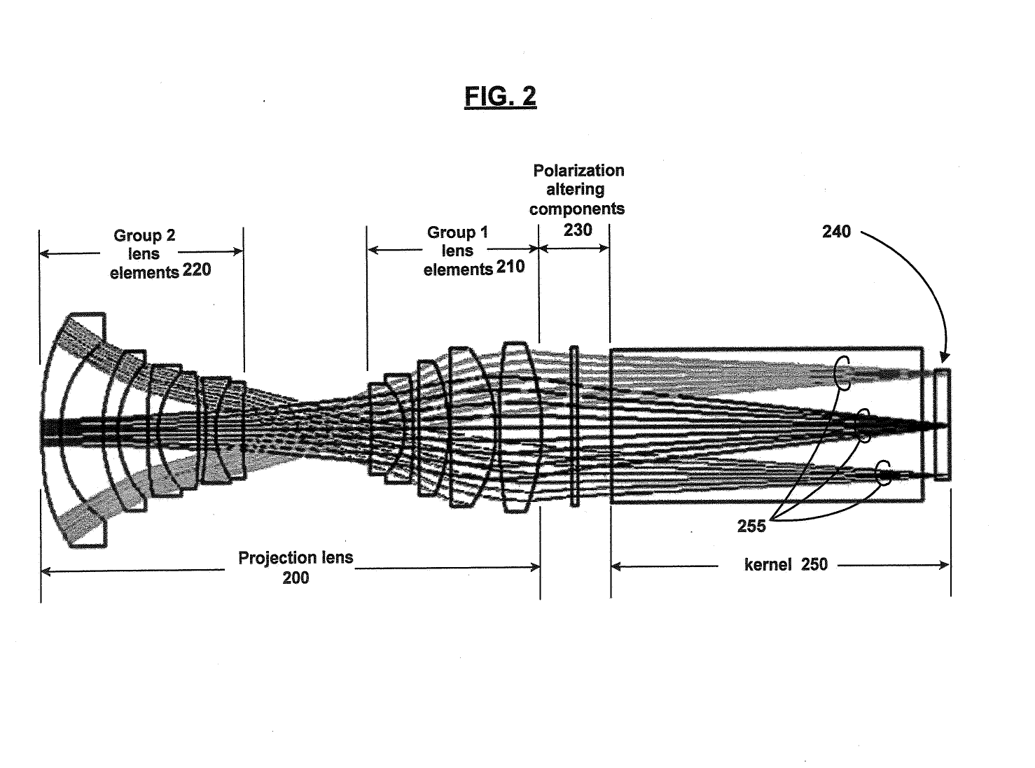

Referring again to the drawings, wherein like reference numerals designate identical or corresponding parts, and more particularly to FIG. 2 thereof, there is illustrated a generic version of a projection lens 200 suitable for use in a projection device. Projection lens 200 includes, for example, a plurality of lens elements. The lens receives light output from kernel 250 after conditioning by polarization altering element 230.

The kernel 250 is illustrated showing a single light channel and modulating device 240. In practice, multiple light channels and multiple modulating devices are generally utilized. The modulating device 240 is, for example, a reflective Liquid Crystal on Silicon (LCoS) microdisplay. The kernel may be, for example, a multi-channel quad style kernel such as the LightMaster Systems™ lms-AT™ kernel.

Ray tracing 255 is illustrated from three points of modulated light from the modulating device 240, through the light channel(s) of the kernel 250, polarization altering element(s) 230, and the lens elements of the projection lens 250. The polarization altering element is, for example, a ColorSelect wavelength dependent retarder.

The lens elements of projection lens 200 can be somewhat artificially divided into 2 groups (e.g., groups 210 and 220). As shown by the ray tracings 255, as light rays travel through the projection lens, they impact surfaces of the lens elements. As described by Fresnel's law, the state of polarization of each light ray is altered at each interface (each lens element surface). The greater the number of lens element surfaces impacted by a light ray the greater the extent to which the light rays' polarization is altered.

A conventional LCOS video projector outputs linearly polarized light. The green and blue light are S-polarized while the red is P-polarized. There are a variety of reasons why it may be desirable to alter the polarization of the output light. These include the following:

Light engines are typically designed so that light rays exit the projection lens at low f#. The reason is that a wide throw angle is needed to minimize television cabinet depth. A consequence of a low f# is that light rays impacting the perimeter of the screen (e.g., the Fresnel lens) do so at a steep angle. This, in turn, induces artifacts observable by the viewer. On a Fresnel lens type screen, in the full white bright state, this artifact appears as coloration at the corners of the screen. At least three methods currently utilized by which this artifact can be minimized. The first is the use of an output ColorSelect filter. This wavelength dependent retarder serves to rotate the axes of linear polarization of the red, green and blue components into the same orientation. The second is the use of a wide band quarter waveplate. This serves to circularly polarize the output light. The third is the use of a high order waveplate which essentially depolarizes the output light.

Some High Definition Television (HDTV) designs utilize a polarized screen. In this case, the axis of linear polarization of all light output by the light engine needs to be oriented in one direction. One method to accomplish this is to use an output ColorSelect filter.

One configuration by which stereoscopic video images can be created utilizes 2 output polarization altering components. The first is a ColorSelect filter which serves to align the axes of linear polarization of all light along one direction. The second component is a variable retarder that serves to toggle the polarization axis. For example, Berman I, U.S. patent application Ser. No. 11/170,124, entitled “A 3D KERNEL AND PRISM ASSEMBLY DESIGN,” filed Jun. 29, 2005, attorney docket number 356508.03801, the contents of which are incorporated herein by reference in their entirety, describes the production of a stereoscopic image using polarization altering components and a variable retarder.

In all 3 cases, the approach is to locate the polarization altering element(s) between the output of the kernel and the input to the projection lens. The size of the polarization altering component is slightly larger than the ray bundle (area of light output from the kernel) at that position. As a practical matter, the components utilized are about the size of the kernel output face.

It is noted that a major factor determining the cost of polarization altering components is their size. The larger the component, the more it costs. Since it is desirable to reduce light engine cost it follows that it is desirable to reduce the size of the polarization altering components. Furthermore, since it is the function of polarization altering components to transform light output by the light engine into a more desired state of polarization, it follows that it is desirable that subsequent transmission through the projection lens alter the state of polarization as little as possible.

The present invention reduces the size of polarization altering components (thus reducing cost) and minimizes the extent to which polarization is undesirably altered by transmission through the projection lens (thus improving image quality).

In one embodiment, the present invention comprises positioning polarization altering component(s) within the projection lens. As illustrated in FIG. #3, polarization altering component (s) 335 are positioned between lens group 1 (310) and lens group 2 (320). At this point the ray bundle is smallest thus allowing the smallest possible polarization altering components. Note that components can not just be inserted into the projection lens. Rather the projection lens (in conjunction with the kernel) needs to be optically designed to include components at this position.

Note further that the polarization altering component is optically down stream of lens group 1. As a consequence, lens group 1 does not affect the state of polarization established by the polarization altering components 335. In this way, light leaving the projection lens deviates less from its' intended state of polarization because less lens elements are impacted after the polarization is altered when compared to the case in FIG. 2 where both the lens groups 1 and 2 are optically down stream of the polarization altering component). The improvement in the quality of output polarization results in an improvement in the quality of the projected image.

It is also possible to include non-polarization altering components within the projection lens. As one possible example, the component can be a dichroic filter for the purpose of attaining a more neutral black state in the projected image. This type of dichroic is the subject of Berman II U.S. patent application Ser. No. 11/227,865, filed Sep. 15, 2005, entitled “Method and Apparatus to Achieve a Neutral Dark State in Image Projection Systems” by Berman, attorney docket number 356508.05400, the contents of which are incorporated herein by reference in its entirety.

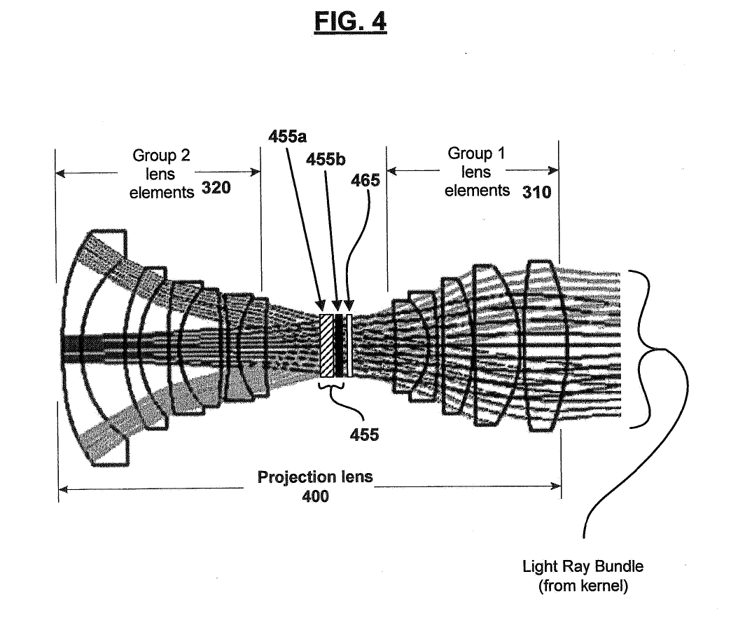

FIG. 4 is a drawing of a projection lens 400 incorporating polarization altering component(s) 465 and a light shutter 455. The functions and operation of the light shutter 455 includes the implementation of one or more image compensating and/or enhancement techniques. For example, a shutter may be effectively programmed to adjust light intensity of an image to maximize the effective range of brightness modulation of the kernel's modulating microdisplays, such as discussed in Berman III, U.S. Pat. No. 11/013,580, filed Dec. 16, 2004 entitled “METHOD AND APPARATUS FOR ADJUSTING LIGHT INTENSITY”, attorney docket no. 356508.04400, and/or removing/suppressing a comet tail effect as discussed in Berman IV, U.S. patent application Ser. No. 11/251,319, filed Oct. 14, 2005, entitled “METHOD AND APPARATUS TO MANAGE LIGHT AND REDUCE BLUR IN MICRODISPLAY BASED LIGHT ENGINES”, attorney docket no. 356508.05600, and/or compensating for light source flicker by increasing/decreasing brightness of input light according to corresponding decreases/increases in brightness of a light source as discussed in Berman V, U.S. patent application Ser. No. 09/152,005, filed Sep. 15, 2005, entitled “METHOD AND APPARATUS TO MINIMIZE LAMP FLICKER AND INCREASE CONTRAST RATIO IN PROJECTION DEVICES”, attorney docket no. 356508.05300, the contents of each of which are incorporated herein by reference in their entirety. Each of the above light intensity adjustments are performed, for example, simultaneously via a single shutter placed within a projection lens and configured according to the present invention.

In one embodiment, the light shutter 455 comprises a variable retarder 455a in optical series with linear polarizer 455b (e.g., a reflective linear polarizer), and the light shutter is disposed in homogenously polarized light path. The light path is homogeneously polarized, for example, due to the polarization altering component(s) 465 or other optics (e.g., optics prior to lens group 2).

In one implementation (using a LightMaster Systems™ lms-AT™ kernel as an example), a green/magenta or a magenta/green ColorSelect wavelength selective retarder is used between the output prism face and the variable retarder as the polarization altering component. The ColorSelect's function is to rotate selected axes of linear polarization of at least one of the red, green and blue output lights so that all of the output lights are polarized in the same (P or S) plane. This polarization input allows the described shutter to function properly. It is desirable for the retarder to switch between 0 and ½ lambda and do so quickly enough to implement the desired light shutter functions. Thus, by energizing the retarder partially or fully effectively reduces or completely blocks light traveling through the projection lens.

The variable retarder is, for example, a type of liquid crystal shutter of which there are many possible and acceptable configurations. In one embodiment, the retarder utilizes a ferroelectric liquid crystal. The reason is that this liquid crystal mode has a fast and symmetrical switching time. An alternative is a liquid crystal shutter based on the either the 0° or Π type surface mode effect.

The placement of the ColorSelect material, dichroics, shutter, and other light modifying elements are preferably disposed at a position in the projection lens where an area of the light ray bundle to be projected from the lens is minimized. The size and shape of the light modifying components are configured to match the size and shape (area) of the light ray bundle at the minimized position. For example, in a light ray bundle having a rectangular shape, the light modifying components also have a rectangular shape of approximately the same dimensions.

The lens elements are typically held in the projection lens via circular rings. A similar arrangement may be used to hold the light modifying elements, except that the light modifying elements would also incorporate a frame that is of a specific size needed to hold the ColorSelect, dichroic, or shutter precisely at the location such that the similarly sized light ray bundle passes through it without impacting the frame.

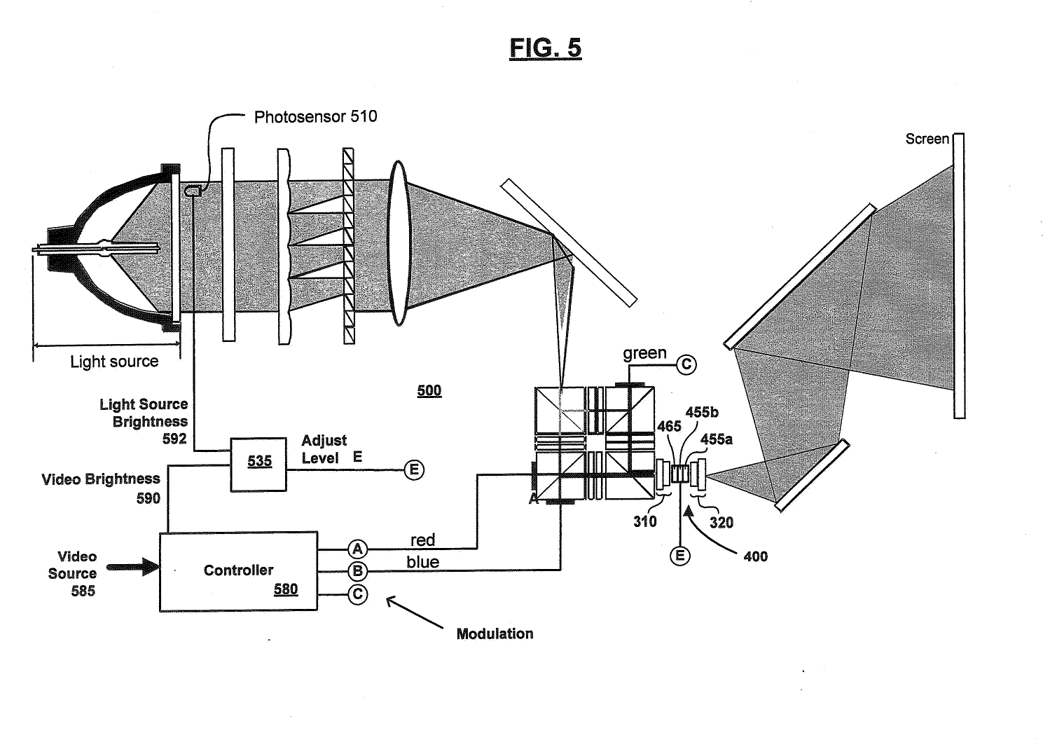

FIG. 5 is a drawing of a video projector 500 having a projection lens with brightness adjustments for both flicker control, contrast ratio improvements, and polarization alteration according to an embodiment of the present invention. A controller 580 receives a video input signal, or video source 585. The Controller 580, for example, prepares separate content signals for each microdisplay of a kernel design (e.g., Red content, Green content, and Blue content). Each content signal is sent to a respective microdisplay positioned in a color light path corresponding to the color of the content signal provided to the microdisplay.

The controller 580 determines, for example, a video brightness of an image to be displayed from a signal of the video source 585. The controller includes, for example, an image brightness circuit that detects a brightness of the image to be displayed from the video source 585. The controller 580 produces, for example, a video brightness signal 590. A light source brightness signal 592 is received from a photosensor 510, which is provided along with the video brightness signal 590 to a combined driver board 535. The combined driver board takes into account both the brightness of the displayed image and the light source brightness and determines an adjustment level (adjust level). The adjustment level is, for example, an amount of energization E to be provided to the variable retarder in order to implement one or more of the above described compensating and/or enhancement techniques. In combination therewith, the amount of modulation is also provided in signals A, B, and C to each of the microdisplays. The totality of the brightness adjustment and modulation signals produces the desired video brightness while implementing any combination of the above described compensating and/or enhancement techniques.

Although the present invention has been mainly described with reference to quad style kernels and video projector lenses, the devices and processes of the present invention may be applied to other kernel designs or lens systems as will be appreciated by the skilled artisan upon review of the present disclosure

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing a polarization altering component, such as embodied by a ColorSelect material, any other equivalent device, such as compensated higher order waveplates, or another device having an equivalent function or capability, whether or not listed herein, may be substituted therewith. Furthermore, the inventors recognize that newly developed technologies not now known may also be substituted for the described parts and still not depart from the scope of the present invention. All other described items, including but not limited to polarizers, shutters, modulators, controllers, etc should also be considered in light of any and all available equivalents.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CDRW+/−, micro-drive, and magneto-optical disks, ROMs, RAMs, EPROMs, EEPROMs, DRAMs, VRAMs, flash memory devices (including flash cards, memory sticks), magnetic or optical cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, detecting brightness in a video image, preparing signals for any of brightness, motion, adjusting modulation levels, and adjusting brightness and/or gray scale modulations according to the processes of the present invention.

The present invention may suitably comprise, consist of, or consist essentially of, any of element (the various parts or features of the invention) and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

What is claimed and desired to be secured by Letters Patent of the United States is:

1. A projection lens, comprising
a first lens;
a second lens; and
a wavelength specific retarder disposed between the first lens and the second lens.

2. The projection lens according to claim 1, wherein at least one of the first lens and the second lens comprises a series of lens elements.

3. The projection lens according to claim 1, wherein the wavelength specific retarder comprises an optical element that changes a polarization of at least one, but not all, of red, green, and blue lights.

4. The projection lens according to claim 1, wherein the wavelength specific retarder is positioned at a smaller light area position compared to a light area input to the projection lens.

5. The projection lens according to claim 4, wherein the smaller light area position is a minimum light area position in the projection lens.

6. The projection lens according to claim 1, further comprising a dichroic element disposed between the first lens and the second lens.

7. The projection lens according to claim 1, further comprising a series of additional third lenses disposed a various locations between the first lens and the second lens.

8. A video projector, comprising:
a modulating kernel configured to modulate an input light with image data;
a projection lens configured to project the modulated light;
wherein the projection lens comprises a plurality of lens elements and a light modifying element disposed at a minimum modulated light area within the projection lens.

9. The video projector according to claim 8, wherein the light modifying element comprises a dichroic filter.

10. The video projector according to claim 8, wherein the light modifying element comprises a waveband dependent retarder.

11. The video projector according to claim 8, wherein the light modifying element comprises a light shutter.

12. The video projector according to claim 11, wherein the light shutter comprises an electronically controlled variable retarder and a polarizer.

13. The video projector according to claim 8, wherein the modulating kernel comprises a quad style prism assembly configured to separate the input light into a series of component light beams, individually modulate the component light beam, and recombine the modulated component light beams.

14. The video projector according to claim 6, wherein the modulating kernel comprises a set of Liquid Crystal on Silicon (LCoS) reflective microdisplays configured to individually modulate the component light beams.

15. A wavelength specific retarder disposed in a projection lens.

16. The wavelength specific retarder according to claim 1 wherein the wavelength specific retarder is disposed between lens elements of the projection lens.

17. The wavelength specific retarder according to claim 15, wherein the wavelength specific retarder is disposed at a minimum light area within the lens.

18. The wavelength specific retarder according to claim 15, wherein the wavelength specific retarder has a size and shape minimized and matched to an area of a light ray bundle passing through the projection lens.

19. The wavelength specific retarder according to claim 15, wherein the projection lens is installed in a lightpath of a High Definition (HD) projection television.

20. The wavelength specific retarder according to claim 19, wherein the projection television comprises a Liquid Crystal Silicon (LCoS) based Rear Projection Television (RPTV).
